(19) United States
(12) Patent Application Publication
(10) Pub. No.: US 2010/0173688 A1
(43) Pub. Date: Jul. 8, 2010

(54) METHOD FOR ENHANCING THE STRATEGY FACTOR IN CARD GAMES

(76) Inventor: Shachar Adiv, Herzliya (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(21) Appl. No.: 12/439,570

(22) PCT Filed: May 10, 2007
(86) PCT No.: PCT/IL2007/000563

§ 371 Date: Apr. 29, 2009

(30) Foreign Application Priority Data
Sep. 7, 2006 (IL) 177954

(51) Int. Cl. A63F 9/24; A63F 13/00

(52) U.S. Cl. 463/13; 463/30

(57) ABSTRACT

Method for enhancing the strategy factor in a card game, according to which a number of cards are dealt to the players, according to the rules of the card game, and at least one of the dealt cards of one or more players is revealed to other players, such that the revealed card is visible to other players. The card game is continued while the other players see the revealed card.

### FIELD OF THE INVENTION

The present invention relates to the field of card and tile games. More particularly, the invention relates to a method for enhancing the strategy factor in known card and tile games for challenging the players and further increasing the enjoyment of these games.

### BACKGROUND OF THE INVENTION

Games of chance can be thought of, as according to two basic varieties: games in which there are no player decisions, and the outcome is essentially entirely random, and games where the players' decisions affect the outcome of the game.

The second type of games, noted above, is typically based on a combination of chance and strategy decisions made by the players, where each game varies in its degree of chance versus strategy. In other words, the outcome of the game partially depends on the players' decisions and partially on their luck. In some of the games, even the players' decisions are based on luck, as their decision is typically based on insufficient information, hidden from the players. Examples of this type of games are: poker (in its many forms, including: Texas Hold'em, Omaha Hold'em), bridge, spades, all of which are played by players concealing their playing cards from the rest of the players.

In each of these games, the player receives an initial “hand” (combination) of cards which he has to conceal from the rest of the players, and then makes one or more decisions about how to proceed in the game. However, the player's decision is usually made without having enough information about other players' hands. Specifically, the player may wish to make these decisions after having some clue about other players' hands.

For example, in a poker game, each of the players is randomly dealt an initial hand of cards. After receiving his randomly dealt cards, each of the players has to decide which of the cards he wishes to exchange, without knowing the dealt hand of the other participants. It may be desirable to allow each player to see some of his rivals' cards in order to apply a strategic decision.

Although in a typical card game, a professional player may be able to do a full analysis of all possible starting hands, the use of such a full analysis may be tiresome and complicated for most players. The inability of a player to properly analyze his options before deciding, eventually leads the player to rely on his luck. However, if some of the cards of the other players are known, the total of possible initial hands is reduced drastically, helping each player to formulate his own strategy.

US 2006/0025193 discloses a method for buying a “peek” in wagering games. The disclosed method allows a player to pay for information which is normally concealed from the player. The additional price for a “peek” may increase according to the amount of information provided, and according to the progress of the game. However, the disclosed method may be implemented only in wager games, where a player gambles and plays for money.

It is an object of the present invention to provide a method for enhancing the strategy factor in card games.

It is another object of the present invention to provide a method for enhancing the playing experience of well known games.

It is still another object of the present invention to provide a method for enhancing the enjoyment of card games by revealing some of the cards of each of the players to the other players where each player does not know which of his cards are revealed.

Other objects and advantages of the invention will become apparent as the description proceeds.

### SUMMARY OF THE INVENTION

The present invention relates to a method for enhancing the strategy factor in a card game. A number of cards are dealt to the players, according to the rules of the card game, and at least one of the dealt cards of one or more players are revealed to other players, such that the revealed card is visible to other players. The card game is continued while the other players see the revealed card.

The card game may be played on a screen of a computer that is connected to a data network, such as a LAN, a WAN, or the Internet. Alternatively, the card game may be played on a screen of a TV that may be connected to a digital converter. The card game may also be played on a portable device, such as a handheld computer, a PSP, an I-POD, or a cellular phone.

Preferably, the card game is played on a specifically designated system for said card game. The card game may be also played with physical cards organized in pairs in clear packages or on a rack capable of revealing some of the cards placed in them.

Preferably, the card game is played in a TV format.

Preferably, the player does not know which of his cards is revealed. The revealed card may be revealed after the beginning of the game and picked from the stockpile.

### BRIEF DESCRIPTION OF THE DRAWINGS

In the drawings:

FIG. 1 depicts a prior art computerized poker game;

FIG. 2 depicts an embodiment of the invention for playing with physical cards;

FIG. 3 depicts another example of the invention for electronically playing Rummikub;

FIG. 4 depicts the prior art Rummikub racks with playing tiles; and

FIG. 5 illustrates an embodiment of the invention, for revealing some of the tiles of the players.

### DETAILED DESCRIPTION OF PREFERRED EMBODIMENTS

For the sake of brevity the following terms are defined explicitly:

Card—any card or tile inscribed with numbers, symbols, pictures, colors, patterns or any combination thereof, used for playing and/or gambling.
Card game—any card game, tile game, or the like, played electronically, mechanically or physically, where at least one of the players is required to conceal his cards from the rest of the players, such as: poker (in its many variations, including: stud poker, draw poker, Texas Hold'em, Omaha Hold'em), rummy, bridge, mini-bridge, deceit, Taki, Rummikub, domino, scrabble, etc.
Rack—a support for holding and displaying cards/tiles.

In prior art card games, each player receives an initial hand of cards which he must conceal from the rest of the players. The concealment, as dictated game rules, has a major role in preventing information from the other players, effectively forcing the other players to make decisions mostly based on mere luck. Therefore, a method is proposed where some of the cards of each player are revealed to the other players, meaning, that a player can make a strategic decision based on factual information of the other players' cards.

As understood, revealing of the cards may be done electronically, mechanically, or physically, where the playing cards may be actual cards or virtual cards, displayed on a display. Furthermore, the platform of the card game may be a computer with or without a data network (LAN or WAN etc.), a TV with or without a digital converter, a portable device (such as a handheld, PSP, I-POD, cellular phone, PDA, etc.), on a specifically designated system for card playing, or on any other known platform.

For the sake of brevity the following embodiment deals with a poker card game played on a computer display, although, as understood, the invention may be used with different embodiments for different games played on different platforms.

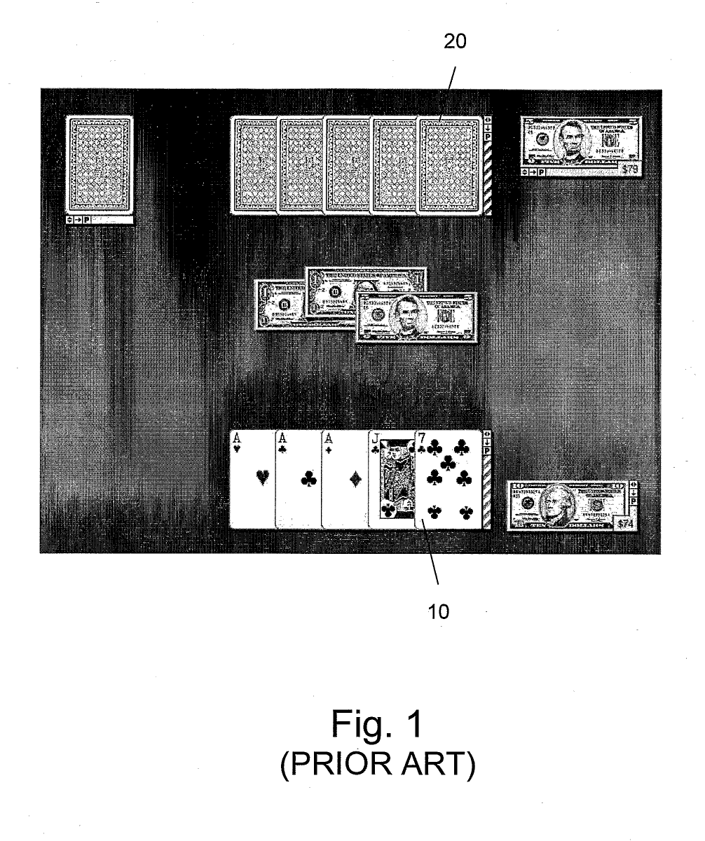

FIG. 1 depicts a prior art computerized poker game. As shown, both players were dealt five cards, where the first player 10 may see his own cards but not his rival's cards. Although player 10 is obviously holding a good hand, he still faces the dilemma of what hand his rival is holding. At first, player 10 has to decide how many cards he wishes to discard. The best strategy for player 10, at this point is to discard two cards: the Jack of clubs and the 7 of clubs. Discarding both cards gives the player a chance to obtain the fourth Ace (Ace of spades) and thus obtain a hand of “four of a kind”. The chances of obtaining the last Ace in this game, assuming that player 10 has no clue of player 20's cards, are 1 out of 47 (52 [full deck]−5 [player 10's hand]), plus 1 out of 46 (total chances of 0.043). One other possible profitable outcome for player 10 is receiving a pair of cards with the same number, obtaining player 10 a hand of “full house”. The chances of obtaining a full house are shown in the following equation:

$$( \frac{6 * 10 + 3 * 2}{47 * 46} * 2 = 0.061 ) ( for explanation see the appendix ) . \qquad [ Eq . 1 ]$$

However, according to an embodiment of the invention, 2 cards belonging to player 20 are revealed, showing the Ace of spades and the 9 of hearts. Therefore, player 10 should change his strategy if he wishes to increase his chances to win. Since player 20 is in possession of the fourth Ace, player 10 should only discard the 7 of clubs for the possibility of obtaining another Jack, which is 3 out of 45 (52 [full deck]−5 [player 10's hand]−2 [known cards of player 20]). The possibility of obtaining another Jack (0.0667) is greater than the chance of obtaining a different pair by discarding two cards, as shown in the following equation:

$$( \frac{6 * 9 + 3 * 3}{45 * 44} * 2 = 0.0636 ) ( for explanation see the appendix ) . \qquad [ Eq . 2 ]$$

However, if player 20 is in possession of a Jack, the best strategy is to discard the Jack of clubs and keep the 7 of clubs. In any case, since it is apparent that player 20 does not have a better hand than player 10, at this stage, player 10's best strategy is to start raising the wager.

Another aspect of the introduced playing method involves the use of acting skills. In prior art games, all players assumed that none of the other players know their cards, a fact which allowed them to act accordingly. However, using this introduced playing method, each of the players has to match his acting to the revealed cards.

In one of the embodiments, the players do not know which of their cards are displayed to the other players, a fact which enhances the surprise factor of the game. For example, one can envision a poker game where one of the players is “poker acting” while the other participants are able to closely evaluate his actual situation.

According to the invention, the number of revealed cards may be determined before dealing the cards, after dealing the cards or the number of revealed cards may be changed during the game. Furthermore, the number of revealed cards may change from player to player, either randomly or intentionally. A mathematical formula or any other method for deciding about the number of revealed cards may be used. Furthermore, the players themselves may decide about the number of revealed cards for each player, or a betting method may be used where each player may receive bonuses for revealing cards.

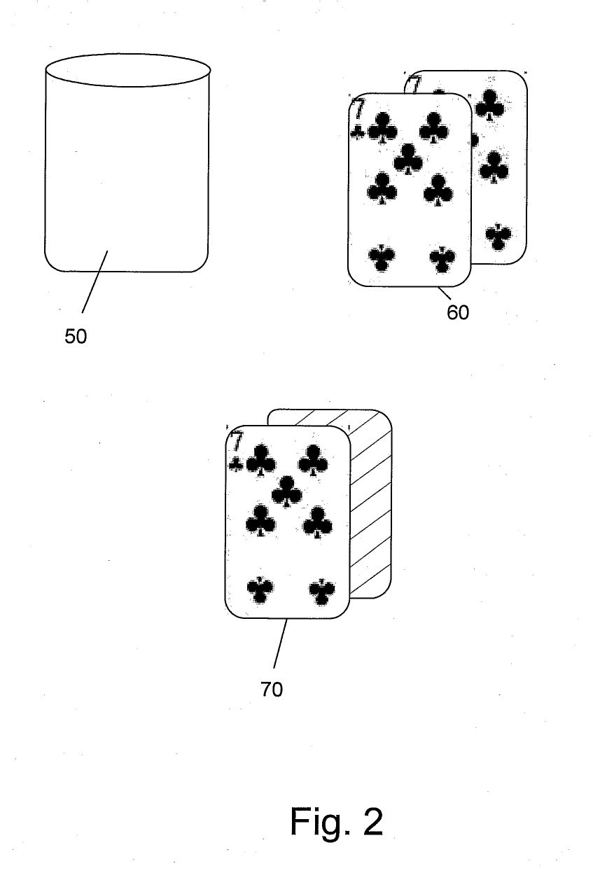

FIG. 2 depicts another embodiment of the invention for playing with physical cards. In this embodiment, the deck of cards is comprised from pairs of identical cards, where each pair is in a transparent package such as package 50. The transparent package 50 may be a transparent plastic bag, a transparent case, or any other package, where two playing cards may be inserted within and the outer covering shows the inner contents from both sides. At the beginning of each game, all the cards are set in pairs where both identical cards are facing the same side, as shown, for example, by pair 60. Each pair is set in its own transparent package 50, where one side of package 50 shows the first card's face (depicting the sign/number/color/suit) and the other side shows the second card's backside, thus concealing the card's face from the other players. Once the cards (i.e. the packages containing pairs of cards) have been dealt to the players, the appointed dealer goes to the first player and selects a predetermined number of cards to reveal. The dealer then opens the packages of the selected cards and turns around the back card, effectually showing in both sides of the package, the same face as shown by pair 70. Thus when the player holds his cards (i.e. the packages containing pairs of cards), the selected cards show their faces to all the players.

In another embodiment, the dealer takes the dealt hand from each player, one at a time, and turns the cards in the package without letting the player know which cards have been turned.

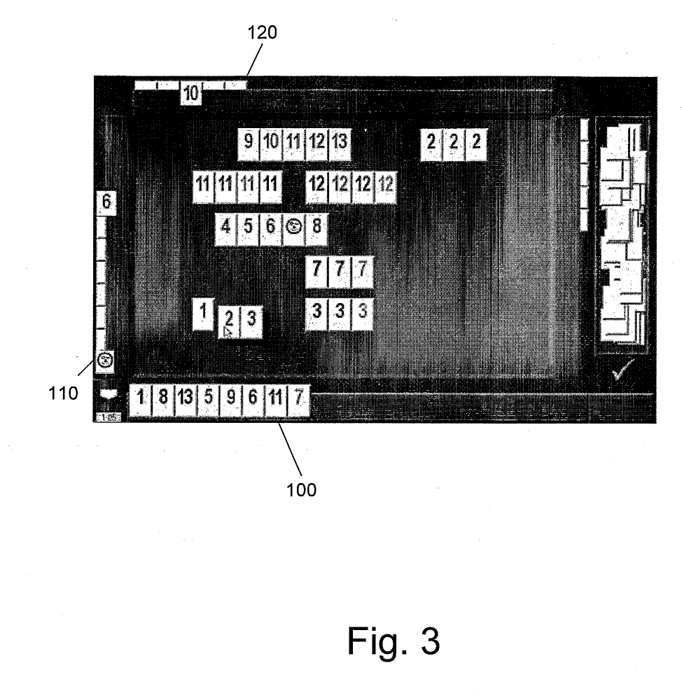

FIG. 3 depicts another example of the invention for electronically playing Rummikub. As shown, player 100 sees the board and cards on a display. Similar to the description above, each player may see some of the other players' cards. In this example, player 100 can see only one card of player 120, and two cards of player 110. Player 100 may discard his red 9 and embed it into the escalating red set ranging from 4 to 8. However, since player 120 has a red 10, player 100 may decide to change his strategy. Instead of discarding the red 9, player 100 can discard his black 13 and embed it into a black 11 and a black 12 series on board.

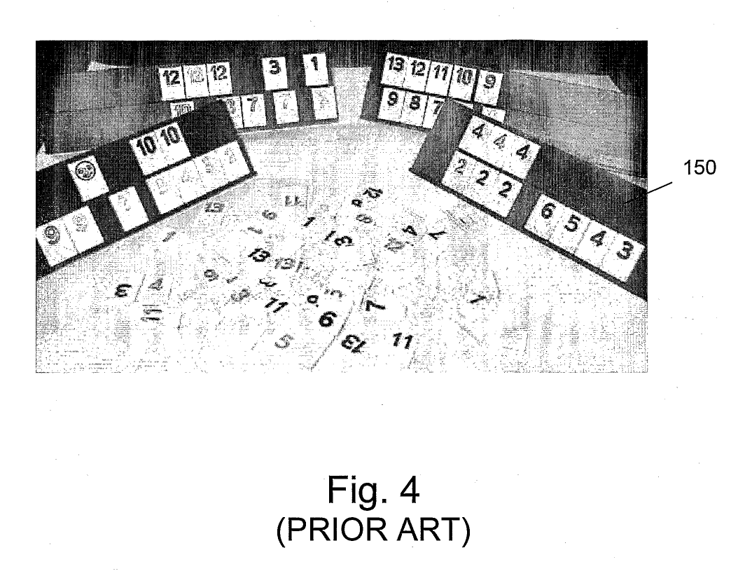

FIG. 4 depicts the prior art Rummikub racks with playing cards/tiles. The shown rack 150 helps the player to hold his cards in order and conceal them from the other players. The cards of the prior art game are one sided tiles on which one of their sides is inscribed with a colored number and their other side is left blank.

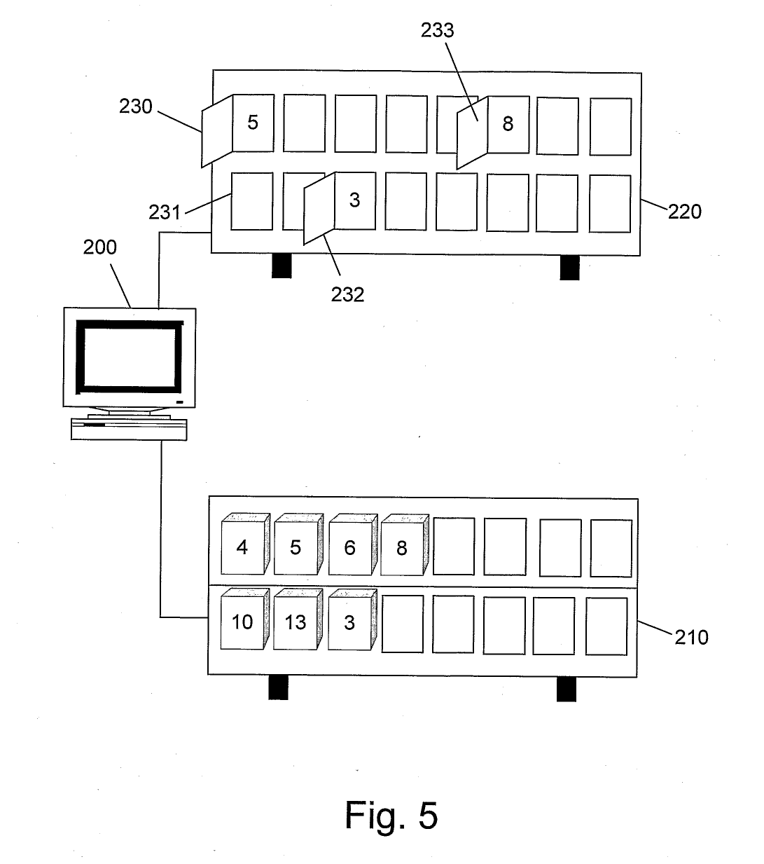

FIG. 5 illustrates an embodiment of the invention, for revealing some of the tiles of the players. For the sake of brevity, all cards, tiles, or playing stones will be referred to hereinafter as tiles. In this embodiment, all tiles are double sided, meaning that the same number/color/symbol is depicted from both sides of the tile. Therefore, the tile stockpile is held in a closed box with an opening, where each player picks his tiles without peeking in the box. At the beginning of the game, each player receives an electric rack such as racks 210 and 220 for placing his tiles. The racks 210 and 220 which are connected to a computer 200 have special cavities for placing the tiles, meaning that the tiles can only be placed in the intended locations of the cavities. In addition, behind each cavity there is an opaque door, such as doors 230 to 233, which can be opened by a signal from the connecting computer 200. For example, after a player picks his tiles and places them on his rack 220 in their cavities, computer 200 sends a signal to rack 220 to open doors 230, 232, and 233. Once the three doors 230, 232, and 233 are opened, all the other players may see the tiles hidden behind them, since the playing tiles are double-sided. The same may be applied to all the other connecting racks, effectively allowing all the players to see some of the tiles of the other players.

In another embodiment, the racks 210 and 220 of FIG. 5 are not electronic and do not connect to a computer, and the doors 230-233 may be opened physically. The dealer, or any one of the players selected for the task, may open any one of the doors, according to the rules agreed on by the players.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

### APPENDIX

### Explanation of Eq. 1

The chances of obtaining a full house (in a deck of 52 cards) while player 10 of FIG. 1 does not know player 20's cards, and when player 10 decides to discard the Jack and 7 of clubs, are shown in the following equation:

$$( \frac{6 * 10 + 3 * 2}{47 * 46} * 2 = 0.061 )$$

The total number of cards unknown to player 10 is 47 (5 cards of player 20 and 42 cards in the stockpile). The total possible matches of selecting any 2 cards are: 47*46, hence the divider. The chances of obtaining a pair of Jacks or 7's, after discarding the Jack and 7 of clubs, is 3*2, since there are only 3 possible combinations of pairs for each. The chance of obtaining any other pair is 6*10, since there are 6 possible combinations of pairs for all the remaining numbers (2, 3, 4, 5, 6, 8, 9, 10, Q, K). Therefore, the total counter is equal to 6*10+3*2. Nevertheless, since the order of the two cards obtained does not matter, the equation is multiplied by 2.

### Explanation of Eq. 2

The chances of obtaining a full house (in a deck of 52 cards) while player 10 of FIG. 1 knows that player 20 is holding the Ace of spades and the 9 of hearts, and when player 10 decides to discard the Jack and 7 of clubs, are shown in the following equation:

$$( \frac{6 * 9 + 3 * 3}{45 * 44} * 2 = 0.0636 )$$

The total number of cards unknown to player 10 is 45 (3 cards of player 20 and 42 cards in the stockpile). The total possible matches of selecting any 2 cards are: 45*44, hence the divider. The chances of obtaining a pair of Jacks or 7's or 9's (Jack of clubs, 7 of clubs and 9 of hearts are not available in the stockpile) is 3*3, since there are only 3 possible combinations of pairs for each. The chance of obtaining any other pair is 6*9; since there are 6 possible combinations of pairs for all the remaining numbers (2, 3, 4, 5, 6, 8, 10, Q, K). Therefore, the total counter is equal to 6*9+3*3. Nevertheless, since the order of the two cards obtained does not matter, the equation is multiplied by 2.

1. A method for enhancing the strategy factor in a card game comprising the steps of:
a. dealing a number of cards to the players according to the rules of playing said card game;
b. revealing at least one of said dealt cards of at least one of said players to other players, such that the revealed card is visible to said other players; and
c. continuing playing said card game while other said players see said revealed card.

2. A method according to claim 1, where the card game is played on a computer screen.

3. A method according to claim 2, where the computer is connected to a data network.

4. A method according to claim 3, where the data network is any one of the following: LAN, WAN, or Internet.

5. A method according to claim 1, where the card game is played on a TV screen.

6. A method according to claim 5, where the TV has a digital converter.

7. A method according to claim 1, where the card game is played on a portable device.

8. A method according to claim 7, where portable device is any one of the following: a handheld, PSP, I-POD, PDA or cellular phone.

9. A method according to claim 1, where the card game is played on a specifically designated system for said card game.

10. A method according to claim 1, where the card game is played with physical cards, organized in pairs, in transparent packages.

11. A method according to claim 1, where the card game is played on a rack capable of revealing some of the cards placed on it.

12. A method according to claim 1, where the card game is played in a TV format.

13. A method according to claim 1, where the player does not know which of his cards is revealed.

14. A method according to claim 1, where the revealed card is revealed after the beginning of the game.

15. A method according to claim 14, where the revealed card is a card picked from the stockpile.
